(19) United States
(12) Patent Application Publication
(10) Pub. No.: US 2006/0255931 A1
(43) Pub. Date: Nov. 16, 2006

(54) Modular design for a security system

(76) Inventors: Andrew J. Hartsfield, Draper, UT (US); Evan I.F. Tree, Sandy, UT (US); Thomas R. Rohlfing, Salt Lake City, UT (US); Jeffrey B. Lancaster, Riverton, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/433,199

(22) Filed: May 11, 2006

Related U.S. Application Data
(60) Provisional application No. 60/681,003, filed on May 12, 2005.

(51) Int. Cl. G08B 1/08

(52) U.S. Cl. 340/538.11; 348/143

(57) ABSTRACT

A security system includes modular components, such as cameras and controllers, controlled by a software application. The modular components are used to customize a security system capable of controlling assorted household and/or building functions. The modular security system has the added benefit that future expansions or functionalities are easily added to the existing system.

### CROSS REFERENCE TO RELATED APPLICATIONS

This application claims priority under 35 U.S.C. §119(e) to U.S. Provisional Patent Application No. 60/681,003, titled “Modular Design For A Security System” to Andrew Hartsfield, et al., filed May 12, 2005, the contents of which are herein incorporated by reference in their entirety.

This application is also related to U.S. patent application Ser. No. 11/325,204, titled “Video Surveillance System” to Thomas R. Rohlfing, et al., Attorney Docket No. 23839-09957, filed Jan. 3, 2006, and to U.S. patent application Ser. No. 11/372,946, titled “Security Camera With Adaptable Connector For Coupling To Track Lighting And Backup System For Fault Tolerance” to Andrew Hartsfield, et al., Attorney Docket No. 23839-11227, filed Mar. 9, 2006, the contents of each are herein incorporated by reference in their entirety.

### BACKGROUND OF THE INVENTION

1. Field of the Invention

This invention relates generally to security and surveillance systems and to automated control of building functions. More particularly, this invention relates to modular components, such as cameras and controllers, that are controlled by a software application and can be used to customize a security system with the capability of controlling various household or building functions.

2. Description of the Related Arts

Traditional security systems include, for example, door and window sensors, motion detectors, and pressure detectors. These sensors and detectors are usually coupled to a central control panel that may communicate with a central monitoring location, for example, an alarm company. Many of these systems, however, do not include video surveillance. Additionally, these systems focus on intruder detection and do not provide additional functionalities, such as remote control over household appliances or systems.

As with traditional home security systems, traditional video surveillance systems do not provide additional functionalities, such as remote control over household appliances or systems. Moreover, traditional video surveillance systems can be costly to install, reducing their practicality in the home security market. Each security camera must be individually mounted to a surface, such as a ceiling or wall, and usually requires wiring to provide electrical power to the camera as well as wiring to transmit the video signal from the camera to a central monitoring location. For example, installing a security system in a typical home with a plurality of cameras can require a full day for two technicians to install. Additionally, such cameras are often obvious to passersby.

Thus, there is a need for a low cost security system that can be easily customized by the user to include multiple functionalities, including, for example, motion detection, video surveillance, and remote control of household (or business) appliances and systems. Such a system could operate, for example, in conjunction with a personal computer (PC), television (TV), or local area network (LAN). Such modular systems have the added benefit that future expansions or functionalities are easily added to the existing system.

### SUMMARY OF THE INVENTION

The present invention includes systems, methods and apparatuses for modular design for a security system including: modular components that capture data and carry out various household, business and/or building functions, and a highly user friendly control system that controls assorted household, business and/or building functions, and displays and stores data transmitted by the modular components.

An exemplary embodiment of modular design for a security system includes: a dual use medium, a universal communication module (UCM) coupled to the dual use medium having input and output for providing a communication channel, a specific function module (SFM) coupled to the UCM adapted for communication with the UCM and to perform a specific function, and a control system having a control transceiver communicatively coupled to the dual use medium for communication with the UCM. The control system includes a software application running on a computing device. The modular design for a security system may also include cameras that communicate with the control system via the dual use medium.

The UCM comprises a communication interface, a universal control unit, and a universal digital interface module. The communication interface has an input and an output for sending and receiving signals over a dual use medium and is coupled to a universal control unit. The universal control unit processes signals sent or received by the UCM and is coupled to a universal digital interface module. The universal digital interface module has an input and an output for communicating with the SFM.

The SFM comprises a specific digital interface module having an input and an output for sending signals to and receiving signals from the UCM and a functional component for executing a specific function, coupled to the specific digital interface module.

In an exemplary embodiment, the SFM further comprises a specific control unit for processing signals sent or received by the SFM coupled to a specific digital interface module.

In an exemplary embodiment, the dual use medium is electrical power wiring, which provides power to the modular components as well as a communication channel through which data is transmitted to the control system.

The features and advantages described in the specification are not all inclusive and, in particular, many additional features and advantages will be apparent to one of ordinary skill in the art in view of the drawings, specification, and claims. Moreover, the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a conceptual drawing of an exemplary embodiment of a modular security system in accordance with the present invention.

FIG. 2 is a block diagram of several exemplary embodiments of specific function modules that may be connected to a universal communication module in accordance with the present invention.

FIG. 3(a) is a front plan view of an exemplary embodiment of a universal communication module and a specific function module in accordance with the present invention.

FIG. 3(b) is a side view of the universal communication module and the specific function module shown in FIG. 3(a).

FIG. 3(c) is a front view of an exemplary embodiment of the specific function module shown in FIG. 3(a).

FIG. 4 is a block diagram of the basic architecture of an exemplary embodiment of the universal communication module and the specific function module.

FIG. 5 is a block diagram of one embodiment of the computing system of the modular security system of FIG. 2.

FIG. 6 is a block diagram of one embodiment of the universal communication module shown in FIG. 4.

FIGS. 7A-7C are block diagrams of embodiments of the specific function module shown in FIG. 4.

FIG. 8 is a block diagram of one embodiment of the memory of the computing system of FIG. 5.

FIG. 9 is a block diagram of one embodiment of the memory of the universal communication module shown in FIG. 6.

FIG. 10 is a functional diagram of a data flow for operation of the memory of the computing device of FIG. 8.

FIG. 11 is a representation of an exemplary embodiment of an indoor covert camera in accordance with the present invention.

FIG. 12A is a perspective view of an exemplary embodiment of an outlet camera in accordance with the present invention.

FIG. 12B is a side view of the outlet camera shown in FIG. 12A.

FIG. 13 is a flowchart of an exemplary embodiment of an initialization process for a modular security system in accordance with the present invention.

### DETAILED DESCRIPTION OF THE PREFERRED EMBODIMENTS

Reference will now be made in detail to several embodiments of the present invention, examples of which are illustrated in the accompanying figures. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

In particular, systems and methods for modular designs for modular security systems are described. The description of the present invention is in the context of modular design for a system that can be used to create a low-cost customized security system and/or to control various appliances and systems, for example, in a house. The system works, for example, in conjunction with a personal computer (PC), television (TV), and/or local area network (LAN). The system has the added benefits that the modules are low profile, and thus their presence may be less obvious to passersby, and installation of additional functionality is as simple as adding an additional specific function module.

It will be apparent, however, to one skilled in the art that the invention can be practiced without these specific details, and home security and functionality is just an example of the application of the principles of the present invention. In other instances, structures and devices are shown in block diagram form to avoid obscuring the invention. However, the present invention applies to any data processing system such as video image processing, surveillance of testing centers, test subjects, and businesses, or other data processing systems for other purposes, and home security and functionality is only used here by way of example.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the present invention claimed below is operating on, or working in conjunction with, an information or computing system. Such a computing system as claimed may be an entire security system, or only portions of such a system. For example, the present invention can operate with a computing system that need only be a digital camera in the simplest sense to process and store video data. Thus, the present invention is capable of operating with any computing system from those with minimal functionality to those providing all the functionality disclosed herein.

Modular Home Security And Functionality System

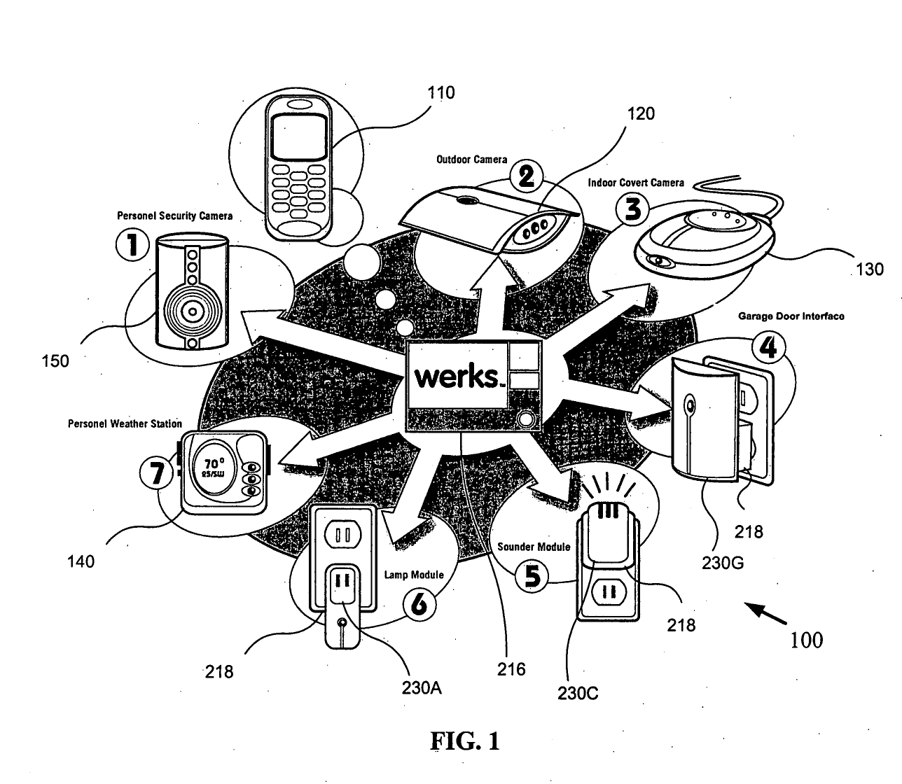

FIG. 1 is a conceptual drawing of an exemplary embodiment of a modular security system 100 in accordance with the present invention. The system 100 may be controlled by a software application running on computing device 216. One example of such an application is the Werks software, which is a comprehensive, yet highly user-friendly, software application that identifies and controls the various modules of the system 100. The software application can support,.for example, viewing, recording, storing, and replaying of data transmitted by system modular components. The software application can also facilitate setting detection zones, setting single or multiple user permissions and rights, and file management of stored files. The software allows a user to modify the settings for the modular components, motion detection, video, connection statistics, recording and playback statistics, recording schedule, and disk usage. An example of the Werks application is described in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety. One skilled in the art will recognize that numerous software applications could be used in accordance with the present invention.

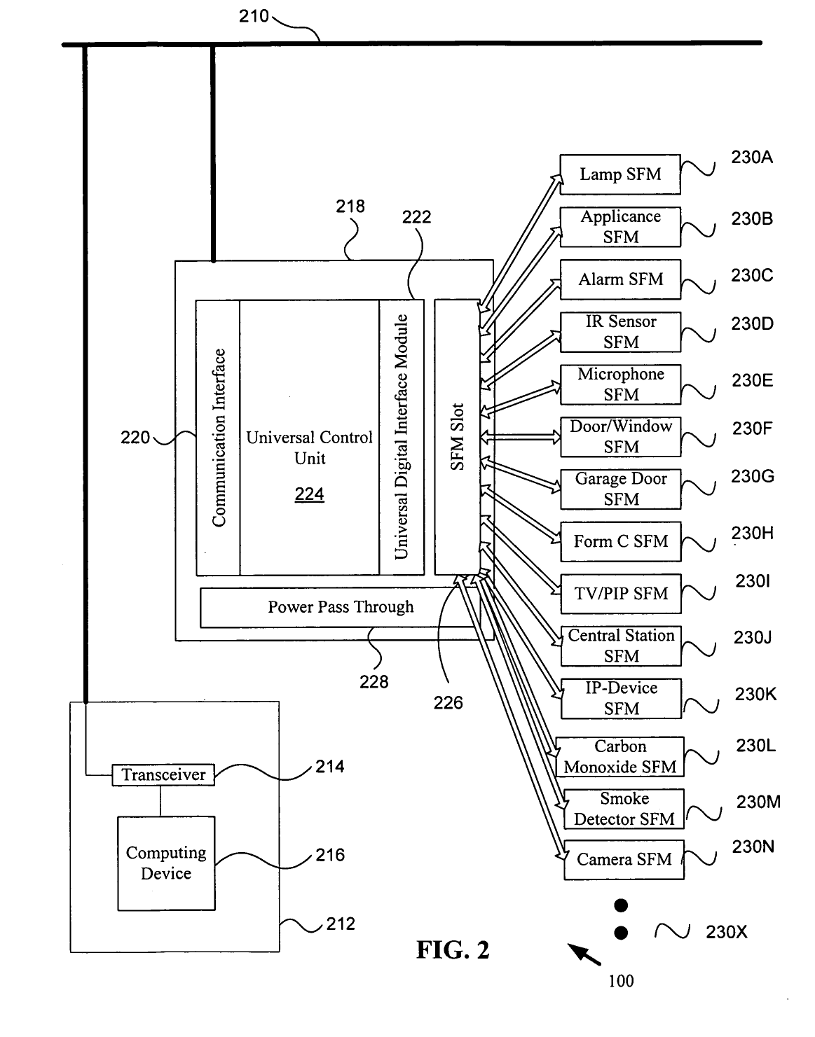

The modular security system 100 is designed to operate using various “plug-in” modules, which can be individually chosen by a user to create a custom system. One or more universal communication modules (UCMs) 218 may be used to provide ports for various specific function modules (SFMs) 230. Some exemplary SFMs 230 are described in more detail below with respect to FIG. 2.

The system 100 may also include, for example, a variety of cameras. One or more indoor personal security cameras 150 may be attached to the system to monitor indoor locations. One or more weather-resistant outdoor cameras 120 may be used to monitor exterior spaces. One or more indoor covert cameras 130 may be used to provide low profile indoor surveillance. One or more outlet cameras 150 may be used to provide portable surveillance capability.

Additionally, the system 100 may be configured to allow a user to remotely access the software application, for example, using a cell phone 110, to remotely control or manage any of the modules connected to the system 100. Those with ordinary skill in the art will realize that the foregoing list of modules is not exclusive, and the software application can be modified to control and manage a variety of other modules as well.

Universal Communication Module and Specific Function Module

FIG. 2 is a block diagram of an exemplary embodiment of a modular security system 100, according to the present invention. The modular security system 100 includes one or more universal communication modules (UCMs) 218, each electrically and communicatively coupled to a dual use medium 210. Each UCM 218 serves as a connection bridge from the dual use medium 210 (in this case, the power grid of a home or business) to any specific function module (SFM) 230. The dual use medium 210 may be, but is not limited to, a power line.

Also coupled to the dual use medium 210 is a control system 212. The control system 212 includes a transceiver 214 to receive data for processing by a computing device 216 running a software application, such as the Werks application, to control the modular security system 100. The transceiver 214 may encrypt outgoing data and decrypt incoming data. The transceiver 214 includes, for example, a USB Receiver Module with built-in surge protection that plugs directly into a wall outlet near the PC 216. A USB cable connects the USB Receiver Module to an available USB port on the PC 216.

As shown in FIG. 2, the UCM 218 includes a communication interface 220, a universal control unit 224, and a universal digital interface module 222. The UCM has a housing that defines a SFM Slot 226 for receiving and mating with an SFM, according to one embodiment. The communication interface 220 protocol may follow one of the common communication protocols, including, but not limited to, IEEE 802.11a, 802.11b, 802.11g, BlueTooth, Zigby, or any HomePlug standard. The universal digital interface module 222 may also follow a basic standard protocol, including, but not limited to, MII bus defined in IEEE 802.3, USB 1.1, USB 2.0, RS232, RS485, or I2C® bus protocol. The universal control unit 224 provides all bridging functions between the communication interface 220 and the universal digital interface module 222. For example, all communication may be buffered, processed, and formatted through the universal control unit 224. The UCM 218 may also provide a power receptacle interface 228 so that it may pass the utility power directly to the SFM 230.

The UCM 218 serves only as a network connection and does not depend on which SFM 230 is using it. Each UCM 218 has a unique MAC address for identification by the software application, which also identifies the function of whichever SFM 230 may be inserted in the UCM 218.

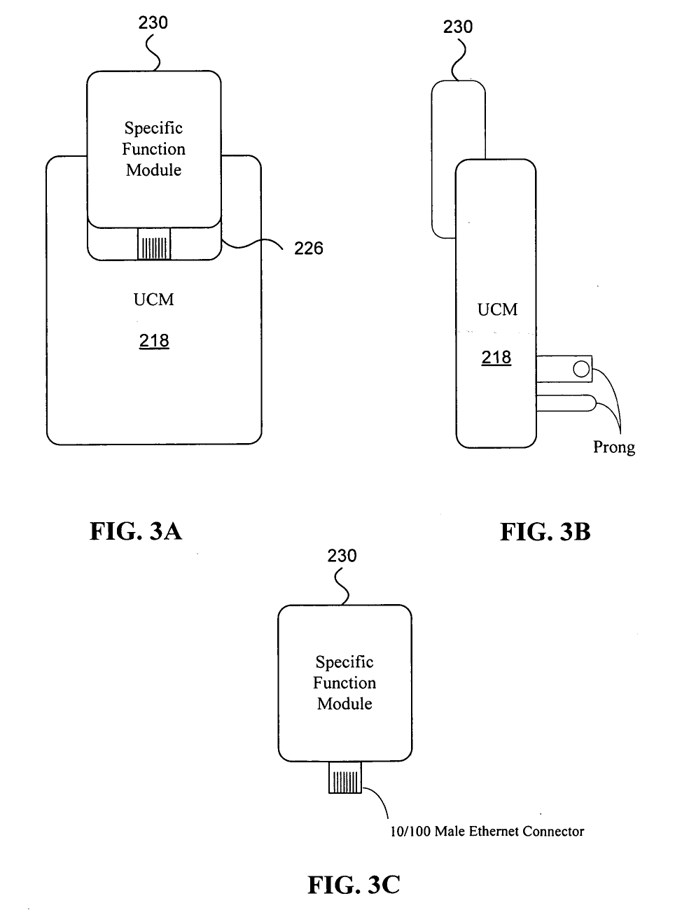

A specific function module 230 may be, for example, a power line switch, an alarm system, an appliance, or serve as a bridge to yet another networking system. The SFMs 230 mate both mechanically and electrically to the UCM 218, as well as provide a compatible bus protocol to the universal digital interface module 222. One way to connect the SFM 230 to the UCM 218 is through SFM Slot 226, according to one embodiment. A representation of such a connection is shown in FIGS. 3A-3B.

FIG. 3A is a front plan view of an exemplary embodiment of a UCM 218 coupled to an SFM 230 in accordance with the present invention. FIG. 3B is a side view of the UCM 218 and the SFM 230 shown in FIG. 3A. A particular specific function module 230 slides into a slot 226 on the UCM 218, thus becoming both mechanically and electrically connected to the UCM 218. The SFM 230 connects to the UCM 218 through either an industry standard communication protocol such as USB, Ethernet, CAN bus, and FireWire or through a multipoint power and communications connector. FIG. 3C shows the SFM 230 and UCM 218 connected through an Ethernet connector, according to one embodiment.

The UCM 218 provides a way to create a network connection, for example, between the software application and a specific function. A specific function may be, for example, a power line switch, a sounder, an alarm system, an appliance, or serve as a bridge to yet another networking system. Those of skill in the art will realize that numerous specific functions are possible.

A light socket coupler provides an alternative means of making the connection between the UCM 218 and the dual use medium 210. Instead of plugging the UCM into an AC wall outlet, as shown in FIG. 3B, a light socket coupler would allow the UCM 218 to screw into a standard light socket (e.g., instead of a light bulb), to provide both the AC power and the digital data connection to the rest of the security system 100. Such sensors may also be used indoors as occupancy and security sensors.

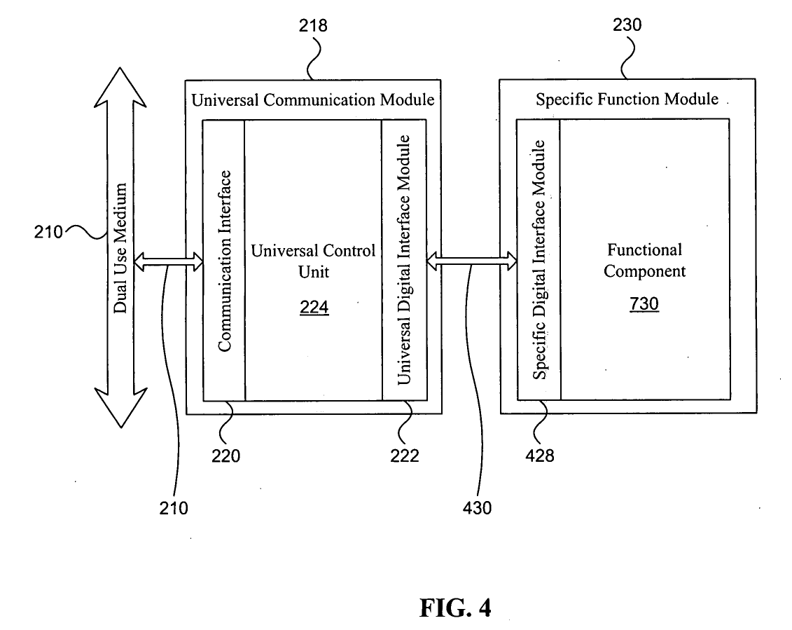

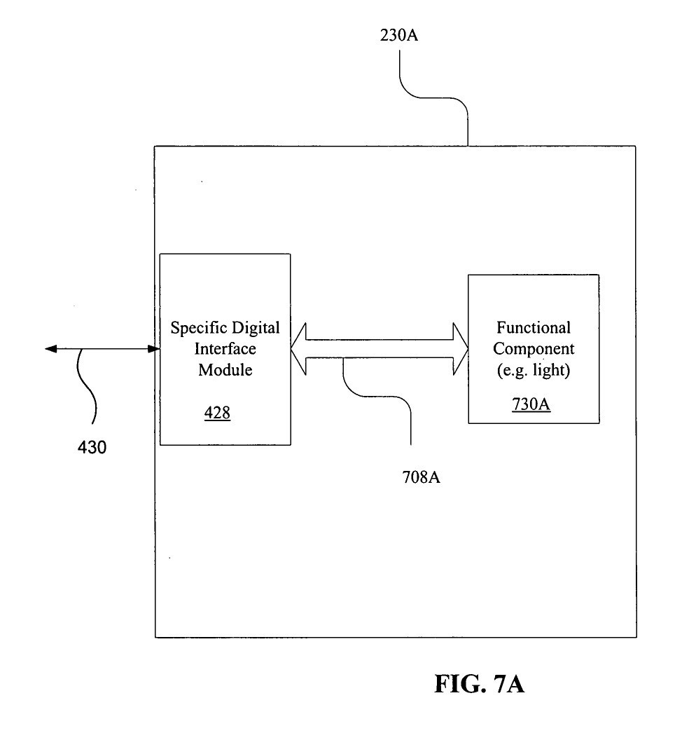

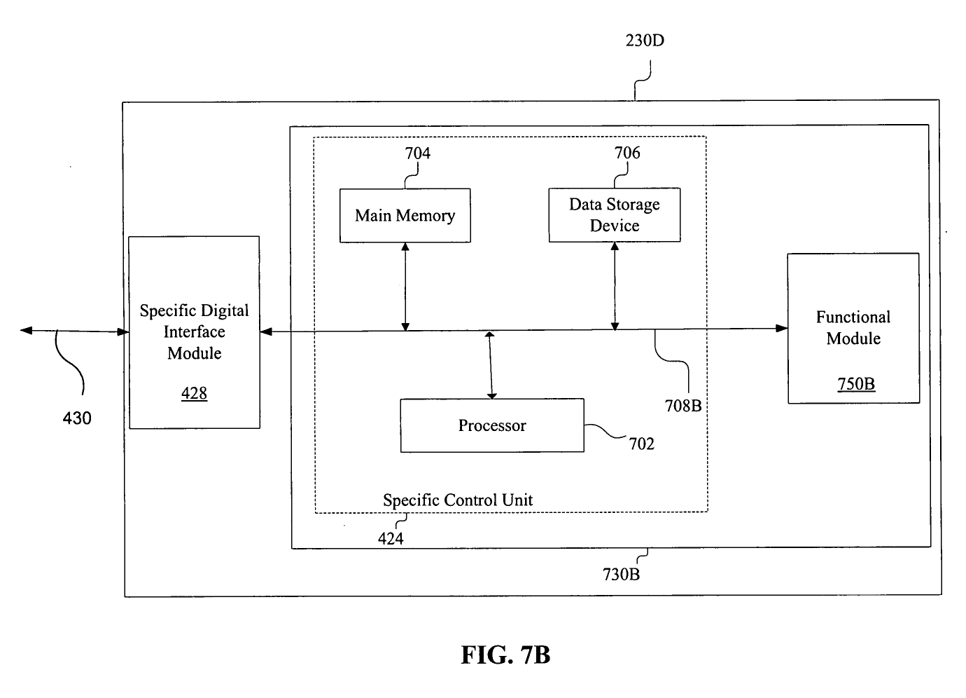

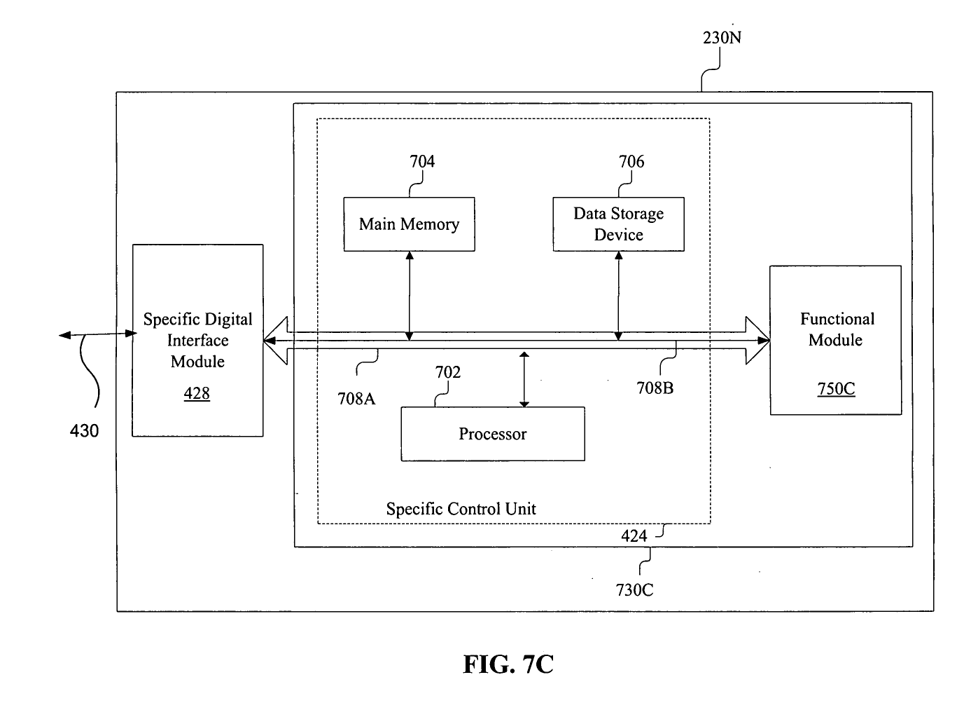

As shown in FIG. 4, the UCM 218 and the SFM 230 communicate over communication path 430. The SFM 230 includes a specific digital interface module 428 and a functional component 730. The SFM may include an optional interface to other devices or networks. The specific digital interface module 428 is used to communicate with the UCM 218 and may follow a data bus standard including, but not limited to, MII bus defined in IEEE 802.3, USB 1.1, USB 2.0, RS232, RS485, or I2C®) bus protocol. Thus, any specific function module 230 is interchangeable and compatible with the UCM 218. The functional component 730 may be as simple as a power switch or may have more complex functionality, such as a video camera. Examples of the varying types of functional components 730 in the SFMs 230 are shown in FIGS. 7A-7C and will be discussed in more detail below. An optional interface to other devices may be included in an SFM 230 to provide bridging services and power to other devices and networks.

Turning back to FIG. 2, several exemplary embodiments of SFMs 230A-230X that may be connected to a UCM 218 are shown. All of the SFMs 230 can be integrated into the software for local and remote control and management. The specific SFMs 230 may be controlled by the software application via the dual use medium 210 and UCM 218. Additionally, an SFM 230 may operate in response to a local event.

A variety of low-bandwidth SFMs 230 may be provided. An exemplary SFM 230 may be a Lamp Module 230A, for example, a 500 Watt dimmer module, which may be controlled by the software application or may operate in response to a light sensor. Alternatively, an exemplary SFM 230 may be an Appliance Module 230B, for example, a 15 Amp on/off module used to control an appliance such as a lamp, a coffee pot, a stereo system, or other such appliances or devices. Alternatively, an exemplary SFM 230 may be a Sounder or Audible Alarm Module 230C, which can be used, for example, to notify a user of intrusion or of children near a pool. Alternatively, an exemplary SFM 230 may include one or more Personal Weather Station Receiver Modules to collect and download weather conditions at local or remote locations where a personal weather station 140 is available.

Alternatively, an exemplary SFM 230 may be an Infrared-Motion Sensor 230D. Such sensors may be used outdoors for lighting control and security, for example, in conjunction with a light socket coupler.

Alternatively, an exemplary SFM 230 may be a Microphone Module 230E, for example, to monitor activity in a child's room. Alternatively, an exemplary SFM 230 may be a Smoke Detector Module 230M to monitor whether a certain level of smoke is detected in a room. Alternatively, an exemplary SFM 230 may be a Carbon Monoxide Detector-Module 230L to monitor whether a certain level of carbon monoxide is detected in a room. Alternatively, an exemplary SFM 230 may be a Door/Window Sensor 230F to identify the opening or closing of a door or window. Alternatively, an exemplary SFM 230 may be a .Garage Door Interface 230G, allowing a user to call in to the software application to cause the garage door to open prior to the user's arrival in the driveway. Alternatively, an exemplary SFM 230 may be a Form C Control Module 230H to provide industry-standard Form C relay. The Form C Control Module 230H provides Form C contacts to control some other device, such as switching an alarm on or off for an alarm panel, or anything else that is designed to interface to external contacts, such as a manual pushbutton.

Alternatively, an exemplary SFM 230 may be a TV/PIP Analog Interface Module 2301 to facilitate sending video from a particular surveillance camera to local home televisions (TV), to other monitors, or to video cassette recorders in other rooms. Having access in any room to video from another, which is a key driver of mass market adoption of video surveillance in the home market, may be accomplished by various methods. For example, a HomePlug enabled digital to analog (D/A) converter box could enable connectivity to analog television inputs, such as s-video or cable inputs. This is accomplished, for example, using Microsoft Connect, or decoding and D/A conversion using a lower power digital signal provider (DSP), or using a commonly available D/A converter for streaming digital media. Key functions in the D/A converter box include the ability to display the cameras in sequence with a dwell time setting that is adjustable from the software application, and the ability to have the on screen image change automatically based on motion detection by any particular system camera.

Another method to send video to local televisions or monitors includes streaming to digital televisions or monitors through media centers. This might be accomplished, for example, using PC TV tuner cards. This would facilitate viewing of a selected camera using the Picture-in-Picture (PIP) input of the television. For example, a front door camera might automatically be displayed on the screen of a television or monitor when someone arrives at the front door. Another method to send video to local televisions or monitors includes streaming to a set-top digital video recorder (DVR) component. Common DVRs from commercial vendors or multiple service operators, such as TiVo, Inc. or various cable companies, may be modified to include back end software to interface with the software application. Another method to send video to local televisions or monitors includes streaming to Internet Protocol (IP)-enabled televisions, allowing video decoding on such televisions using a home's local area network (LAN).

Another exemplary specific function module 230 may be a Central Station Link Module 230J. Such a module may be plugged into an outlet and located, for example, near an alarm siren. The software application would open a communication path or link to a central monitoring station when the noise level from the siren reached a programmed decibel (dB) level. Central Station Link Modules 230J would be particularly useful in areas where police dispatch to an unverified alarm is prohibited. Alternative embodiments to restrict alarm monitoring except in alarm conditions might include, for example, a HomePlug-enabled alarm verification module to allow central station viewing of local cameras only in the event of an alarm, an Insteon-enabled module hard-wired into an alarm bell circuit that would communicate to the software application on a host PC that an alarm is active, and network-enabled alarm panels that would communicate to the software application on a host PC to open a communication path to a central monitoring company.

Another exemplary specific function module 230 facilitates interfacing with any IP-enabled device in a home. Such an SFM 230 would provide a link between the software application and the IP-enabled device. A user could access the software application, either locally from the host PC or remotely from a phone, to receive data from the IP-enabled device and, potentially, to control the device. This would be useful, for example, in the context of second homes or vacation homes. IP-enabled devices may include, for example, security panels, control panels for sprinkler systems, weather station data collectors, spa/hot tubs, appliances, HVAC systems, and snow-melt systems.

Another exemplary embodiment of an SFM 230 is a video surveillance camera 230N in accordance with the present invention. The camera can capture events and feed full-colored, digital streaming video to the software application. The electrical wiring of the user's home or small business not only powers the camera, but also provides a secure conduit through which video is transmitted from the camera to the software application via the UCM 218. An example of a video surveillance system incorporating cameras to transmit the video signal to a personal computer is described in U.S. patent application Ser. No. 11/325,204, titled “Video Surveillance System” to Thomas R. Rohlfing, et al., Attorney Docket No. 23839-09957, filed Jan. 3, 2006.

Another exemplary embodiment of an SFM 230 is a lamp module 230A. The on/off status of the lamp may be controlled by the software application; for example, the Werks application may switch the lamp module 230A on or off at specific times of the day or night, depending, for example, on a weekly schedule set by the user. Alternatively, the software application may turn the lamp on to facilitate video recording by a camera in the same zone. Alternatively, the lamp module 230A may include a light sensor that will turn the lamp on automatically in low light conditions. Alternatively, the lamp module 230A may include an infrared motion sensor to turn the lamp on in response to a motion-based event. The software application may monitor the status of the lamp module 230A and coordinate operation of the lamp with other modules in the system, for example, with nearby cameras. The lamp module 230A may also include a power pass through, so that the power receptacle is available for use by other appliances.

The modular security system 100 may include one or more personal weather station receiver modules to collect and download weather conditions at local or remote locations. Personal weather stations 140, for example, by Radio Shack, are designed to sit on the roof of a building or house and collect data on ambient weather conditions. The data is transmitted wirelessly to a battery-operated handset that can be held by a user. The weather data transmitted by the personal weather station 140 can also be received by the software application, for example, using an SFM 230 that is a personal weather station receiver module and that is plugged into a UCM 218. The SFM 230 personal weather station receiver module receives the data signal from the personal weather station 140, and then transmits the signal through the UCM 218 to the dual use medium (e g., the building power grid) and thus to-the software application. A user could then access the software application, for example, either locally or over a phone from any remote location, to receive the weather information.

Note that many of the exemplary items mentioned could be used in conjunction with a light socket coupler, which would allow the UCM to be screwed into a standard light socket rather than plugged directly into an AC wall outlet, to get both the AC power and the digital data connection to the rest of the security system 100.

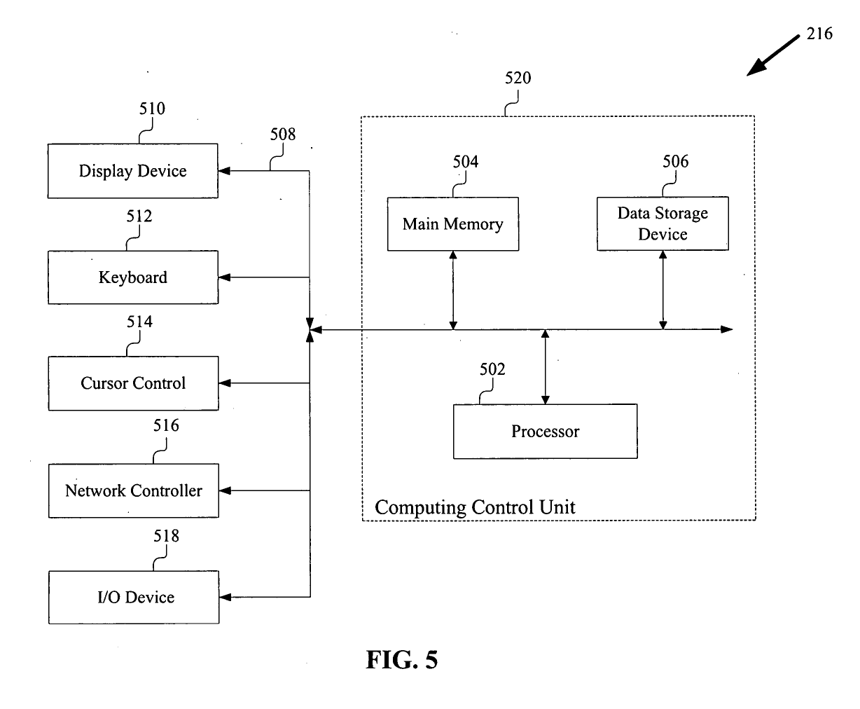

FIG. 5 is a block diagram of one embodiment of the computing device 216 of the modular security system 100 of FIG. 2. The computing device 216 comprises a computing control unit 520, a display device 510, a keyboard 512, a cursor control 514, a network controller 516, and one or more I/O device(s) 518.

The computing control unit 520 may comprise an arithmetic logic unit, a microprocessor, a general purpose computer, a personal digital assistant, or some other information appliance equipped to provide electronic display signals to the display device 510. In one embodiment, the computing control unit 520 comprises a general purpose computer having a graphical user interface, which may be generated by, for example, a program written in Java running on top of an operating system like WINDOWS® or UNIX® based operating systems. In one embodiment, one or more application programs are executed by the computing control unit 520 including, without limitation, word processing applications, electronic mail applications, financial applications, and web browser applications.

The computing control unit 520 is shown including a processor 502, a main memory 504, and a data storage device 506, all of which are communicatively coupled to a system bus 508.

The processor 502 processes data signals and may comprise various computing architectures including a complex instruction set computer (CISC) architecture, a reduced instruction set computer (RISC) architecture, or an architecture implementing a combination of instruction sets. Although only a single processor is shown in FIG. 5, multiple processors may be included.

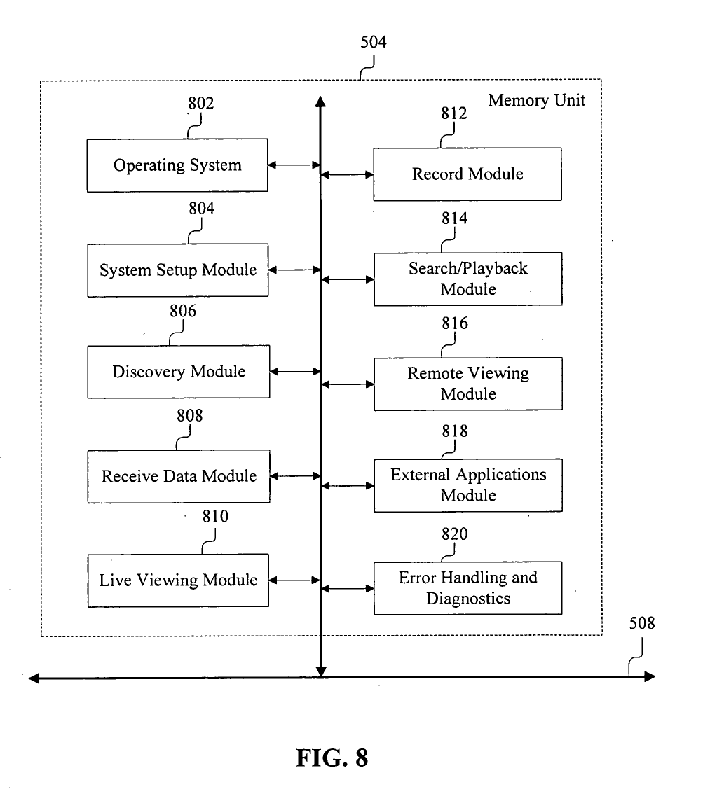

The main memory 504 stores instructions and/or data that may be executed by the processor 502. The instructions and/or data may comprise code for performing any and/or all of the techniques described herein. The main memory 504 may be a dynamic random access memory (DRAM) device, a static random access memory (SRAM) device, or some other memory device known in the art. The main memory 504 is described in more detail below with reference to FIG. 8. In particular, the portions of the main memory 504 for initializing and operating the modular security system 100 will be described.

The data storage device 506 stores data and/or instructions for the processor 502 and comprises one or more devices including a hard disk drive, a floppy disk drive, a CD-ROM device, a DVD-ROM device, a DVD-RAM device, a DVD-RW device, a flash memory device, or some other mass storage device known in the art. The data storage device 506 may include a database for storing data electronically.

The system bus 508 represents a shared bus for communicating information and data throughout the computing control unit 520. The system bus 508 may represent one or more buses including an industry standard architecture (ISA) bus, a peripheral component interconnect (PCI) bus, a universal serial bus (USB), or some other bus known in the art to provide similar functionality. Additional components coupled to the computing control unit 520 through the system bus 508 include the display device 510, the keyboard 512, the cursor control 514, the network controller 516, and the I/O audio device(s) 518.

The display device 510 represents any device equipped to display electronic images and data. The display device 510 may be, for example, a cathode ray tube (CRT), liquid crystal display (LCD), or any other similarly equipped display device, screen, or monitor.

The keyboard 512 represents an alphanumeric input device coupled to the computing control unit 520 to communicate information and command selections to the processor 502.

The cursor control 514 represents a user input device equipped to communicate positional data as well as command selections to the processor 502. The cursor control 514 may include a mouse, a trackball, a stylus, a touch screen, cursor direction keys, or other mechanisms to cause movement of a cursor.

The network controller 516 links the computing control unit 520 to a network that may include multiple processing systems. The network of processing systems may comprise a local area network (LAN), a wide area network (WAN) (e.g., the Internet), and/or any other interconnected data path across which multiple devices may communicate. The computing control unit 520 also has other conventional connections to other systems such as a network for distribution of data using standard network protocols such as TCP/IP, http, and SMTP as will be understood to those skilled in the art. The network controller 516 can be used to couple the modular security system 100 to a data storage device, and/or other computing systems.

One or more I/O devices 518 are coupled to the system bus 508. For example, the I/O device 518 may be a microphone for input and transmission of audio output via speakers. Optionally, the I/O audio device 518 may contain one or more analog-to-digital or digital-to-analog converters, and/or one or more digital signal processors (DSP) to facilitate processing.

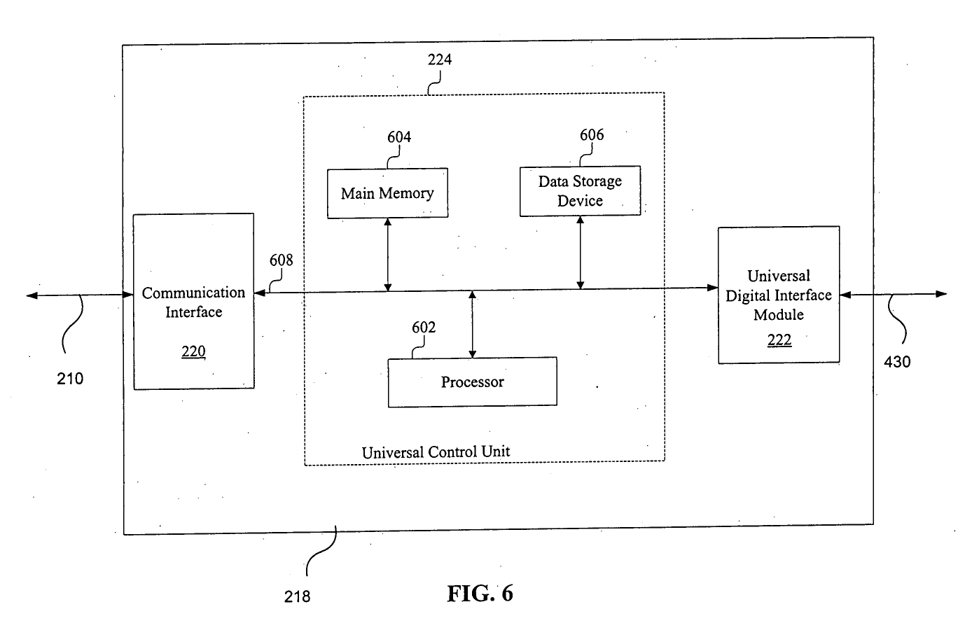

FIG. 6 is a block diagram of one embodiment of the universal communication module 218 of the modular security system 100 of FIG. 2. The universal control unit 224 as shown in FIG. 6 includes some components similar to the computing device 216 shown in FIG. 5. The universal control unit 224 is coupled to the communication interface 220 and the universal digital interface module 222. One of the primary functions of the UCM 218 is to establish a connection with the computing device 216 and to translate the data and commands to and from the SFM 230.

Like the computing control unit 520 of the computing device 216, the control unit 224 of the universal communication module 218 may comprise an arithmetic logic unit, a microprocessor, a microcontroller, or some other information appliance equipped to provide electronic signals to, and to receive electronic signals from, the SFM 230 via the universal digital interface module 222 and/or the computing device 216 via the communication interface 220.

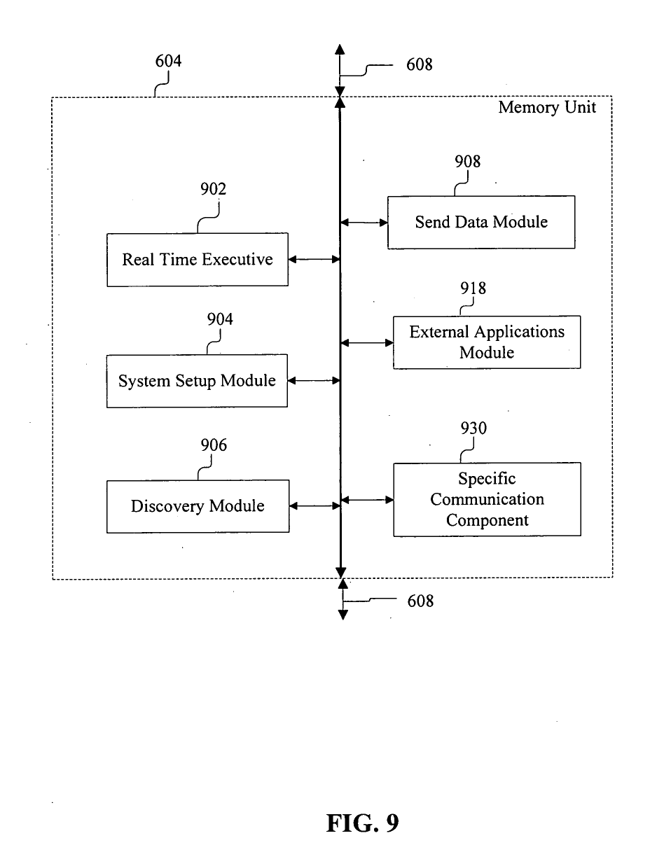

The universal control unit 224 is shown including a processor 602, a main memory 604, and a data storage device 606, all of which are communicatively coupled to communication interface 220 and the universal digital interface module 222 via system bus 608. Like the processor 502 of FIG. 5, the processor 602 processes data signals and may comprise any of the various computing architectures described above with respect to the processor 502. Like the main memory 504 of FIG. 5, the main memory 604 stores instructions and/or data that may be executed by the processor 602 and may comprise any of the various embodiments described above with respect to the main memory 504. The instructions and/or data may comprise code for performing any and/or all of the techniques described herein. The main memory 604, particularly portions for initializing and operating the modular security system 100, is described in more detail below with reference to FIG. 9. Like the data storage device 506 of FIG. 5, the data storage device 606 stores data and/or instructions for the processor 602 and may comprise any of the embodiments described above with respect to the data storage device 606. Like the system bus 508 of FIG. 5, the system bus 608 represents a shared bus for communicating information and data throughout the universal control unit 224 and may comprise any of the embodiments described above with respect to the system bus 508. The UCM 218 communicates with the SFM 230 over communication path 430.

FIGS. 7A-7C are block diagrams of various embodiments of specific function modules 230 of the modular security system 100 of FIG. 2. In FIG. 7A, the specific function module 230 depicted is the Lamp Module 230A. In this embodiment, the functional component 730A includes a light. Power is passed via communication path 430 from the UCM 218 through the specific digital interface module 428. The functional component 730A receives power through power line 708A.

In FIG. 7B, the specific function module 230 depicted is the IR Sensor Module 230D. In this embodiment, the functional component 730B includes a specific control unit 424 and a functional module 750B. Data is passed via communication path 430 from the UCM 218 through the specific digital interface module 428. The functional component 730B receives control signals through data path 708B. The IR Sensor (not shown) is located within functional module 750B.

The specific control unit 424 as shown in FIGS. 7B-7C includes some components similar to the computing device 216 shown in FIG. 5. The specific control unit 424 is coupled to the specific digital interface module 428 and the functional module 750. The specific control unit 424 may also be coupled to an optional interface to other devices or networks. The specific control unit 424 may provide common network protocols, including, but not limited to, TCP/IP, UDP/IP, UPnP, RTP, RTCP, etc. to communicate with the UCM 218.

Like the computing control unit 520 of the computing device 216, the specific control unit 424 of the SFM 230 may comprise an arithmetic logic unit, a microprocessor, a microcontroller, or some other information appliance equipped to provide electronic signals to, and: to receive electronic signals from, the SFM 230 via specific digital interface module 428 and/or the functional module 750.

The specific control unit 424 is shown including a processor 702, a main memory 704, and a data storage device 706, all of which are communicatively coupled to the system bus 708A. Like the processor 502 of FIG. 5, the processor 702 processes data signals and may comprise any of the various computing architectures described above with respect to the processor 702.

Like the main memory 504 of FIG. 5, the main memory 704 stores instructions and/or data that may be executed by the processor 702 and may comprise any of the various embodiments described above with respect to the main memory 704. The instructions and/or data may comprise code for performing any and/or all of the techniques described herein. The memory 704 comprises a universal communication component coupled for communication with the specific digital interface module 428 and functional module 750 via bus 708B according to one embodiment. In another embodiment, universal communication component is located in the specific digital interface module 428.

The universal communication component triggers an announcement of the presence of an SFM 230 coupling with the UCM 218 in the modular security system 100. The universal communication component transmits data from the SFM 230 to the UCM 218, and to the SFM 230 from the UCM 218. Various other components known by one of ordinary skill in the art may be incorporated within memory 704 to carry out the functions of the particular SFM 230.

Like the data storage device 506 of FIG. 5, the data storage device 706 stores data and/or instructions for the processor 702 and may comprise any of the embodiments described above with respect to the data storage device 506. Like the system bus 508 of FIG. 5, the system bus 708A represents a shared bus for communicating information and data throughout the specific control unit 424 and may comprise any of the embodiments described above with respect to the system bus 508.

In FIG. 7B, path 708B represents data flow through the specific digital interface module 428 to the specific control unit 424 and to the functional module 750B.

FIG. 7C shows both the power flow 708A and data flow 708B through the specific digital interface module 428 to the specific control unit and to the functional module 750C. The SFM 230 depicted in FIG. 7C is that of a Camera Module 230N. The various components of the specific control unit 424 in FIG. 7C operate similarly to those in FIG. 7B, although FIG. 7C shows not only the data flow path 708B of FIG. 7B, but also the power flow 708A. Similar to the IR sensor in FIG. 7B, the camera functionality is located within the functional module 750B. An example of a video surveillance system incorporating cameras to transmit the video signal to a personal computer is described in U.S. patent application Ser. No. 11/325,204, titled “Video Surveillance System” to Thomas R. Rohlfing, et al., Attorney Docket No. 23839-09957, filed Jan. 3, 2006.

It should be apparent to one skilled in the art that the control units 520, 224 and 424 may include more or less components than those shown in FIGS. 5-6 and 7B-7C without departing from the spirit and scope of the present invention. For example, the control units 520, 224 and 424 may include additional memory, such as, for example, a first or second level cache, or one or more application specific integrated circuits (ASICs). Furthermore, the control units 224 and 424 need not include the data storage device 606 and 706 respectively.

Software Architecture

FIG. 8 is a block diagram of one embodiment of the memory 504 of the computing device 216 of FIG. 5. In particular, the portions of the memory 504 needed for the initialization and operation of the modular security system 100 according to the present invention are shown and will now be described more specifically. Those of skill in the art will appreciate that, in an alternative embodiment, the modules described in FIG. 8 may reside in the data storage device 506 rather than the memory 504. Although reference is made specifically to the situation where the SFM 230 is a camera, this is merely for convenience and the discussion is not limited a particular SFM.

As shown in FIG. 8, the memory 504 may comprise: an operating system 802, a system setup module 804, a discovery module 806, a receive data module 808, a live viewing module 810, a record module 812, a search/playback module 814, a remote viewing module 816, an external applications module 818, and an error handling and diagnostics module 820, all coupled for communication with each other and with the computing control unit 520 by the bus 508.

The operating system 802 is preferably one of a conventional type such as, WINDOWS®, MAC®, SOLARIS®V or LINUX® based operating systems. Although not shown, the memory 504 may also include one or more application programs including, without limitation, word processing applications, electronic mail applications, financial applications, web browser applications, and the software application.

The system setup module 804 is for initializing the modular security system 100 in accordance with the present invention. The system setup module 804 is responsive to the control environment and to input to the modular security system 100 and in response determines initial system parameters for the security system 100. The system setup module 804 is coupled to the discovery module 806 to determine the presence of the UCM 218 and the SFM 230, and it communicates with the live viewing module 810, the record module 812, and the search/playback module 814 to provide initial system setup parameters. The system setup module 804 preferably includes at least one wizard for automatically detecting and setting the operating parameters of the UCM 218, the SFM 230 and the control system 212.

The discovery module 806 is coupled to the system setup module 804 and detects the presence of the UCM 218 and the SFM 230 in the modular security system 100. The discovery module 806 also facilitates reestablishing the connection to the UCM 218 when the connection is broken.

The receive data module 808 processes data received from the UCM 218 over the dual use medium 210. The receive data module 808 converts the data signal from the format used to transmit over the dual use medium 210 into a format proper for processing by the control unit 212. In particular, the receive data module 808 interfaces with the live viewing module 810 and the record module 812, both of which process the data. The receive data module 808 may also decrypt the data signal if encryption is being used.

The live viewing module 810 works in conjunction with the receive data module 808 to provide live viewing of the data received by the receive data module 808. The live viewing module 810 provides a graphical user interface that allows a user to interact with the modular security system 100. In particular, the live viewing module 810 facilitates activation and deactivation of the UCM 218 and the SFM 230, changing of the viewing window format, changing of system parameters, access to the record mode, and access to the search/playback mode.

The record module 812 works in conjunction with the receive data module 808 to record the data received by the receive data module 808. The record module 812 is responsive to user input to set the recording schedule for particular specific function modules 230, to set motion detection zones, and to allow recording in panic mode.

The search/playback module 814 is coupled to the data storage device 506 to allow searching and playback of previously recorded data. The search/playback module 814 provides a graphical user interface that allows a user to interact with the modular security system 100. In particular, the search/playback module 814 facilitates searching through previously recorded data segments, playback of particular selected data segments, changing of the viewing window format, changing of system parameters, access to the record mode, and access to the live viewing mode.

The operation of the system setup module 804, the discovery module 806, the receive data module 808, live viewing module 810, record module 812 and search/playback module 814 within a security system containing video cameras is described in more detail in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety.

The remote viewing module 816 works in conjunction with the network controller 516 and the receive data module 808 to send the data received by the receive data module 808 to a remote location to facilitate remote viewing of the data. The remote viewing module 816 may include several functionalities. For example, the remote viewing module 816 captures video frames from the video pipeline. It may perform conversion from the current video pipeline frame rate to a frame rate, which may be higher or lower than the video pipeline frame rate, suitable for remote streaming. The remote viewing module 816 may perform resampling of the video data format (i.e., pixel resolution) from the video pipeline video format to a data format suitable for remote streaming. This data format is usually lower than the video pipeline format, but not necessarily. For one-camera module view modes, the remote viewing module 816 may perform selection of which camera module, out of N, is to be streamed for remote viewing at a particular moment in time. This can be either a fixed selection, or the remote viewing module 816 can cycle through the N camera modules, or through M selected camera modules out of N, one at a time. For multi-camera view modes, the remote viewing module 816 may assemble mosaic formats, such as a 2×2 mosaic, of multiple camera module images into a single video stream for remote viewing. Lastly, the remote viewing module 816 may communicate with a remote viewing server to provide status of the modular security system 100 and/or the UCM 218 and SFM 230. Those of skill in the art will appreciate that this list of functionalities is not exclusive and that not all of these functionalities will be used under all conditions.

The external applications module 818 allows the modular security system 100 to provide video and control interfaces to other associated applications. The external applications module 818 works in conjunction with the receive data module 808 to facilitate sending of the data received by the receive data module 808 to the external applications. The external applications module 818 may also work in conjunction with the network controller 516 to send the data to remote applications. As an example, a second computing device, such as a PC running the Windows XP® Media Center Edition (MCE) operating system, may be connected to the user's television or another video display system. The MCE PC can be interfaced to the modular security system 100 over a LAN or other network. A software module running on the MCE PC provides a user interface for the user to control the modular security system 100 remotely from the MCE PC, to view data from the UCM 218 and SFM 230, and/or to be notified of motion events, among other functionalities. For example, if the user is watching a television program using the MCE PC and a large screen TV, the external applications module 818 would allow a message to pop up saying “Camera 2 has detected motion. Do you wish to see this video?” Alternatively, the external applications module 818 would enable the video data to appear in a picture-in-picture window for a period of time. Thus, the MCE PC provides a mechanism to watch and control the modular security system 100 using the TV and the MCE PC. Those of skill in the art will appreciate that this example of an external application communicating with the modular security system 100 via the external applications module 818 to provide expanded system-wide functionality is merely illustrative, and other scenarios are possible.

The error handling and diagnostics module 820 works in conjunction with several of the preceding modules to handle and diagnose errors, for example, regarding data transmission or communication. For example, the error handling and diagnostics module 820 may work with the discovery module 806 in the event of a lost connection to the UCM 218. As another example, the error handling and diagnostics module 820 may work with the receive data module 808 in the event of an incomplete data stream.

FIG. 9 is a block diagram of one embodiment of the memory 604 of the UCM 218 of FIG. 4. In particular, the portions of the memory 604 needed for the initialization and operation of the UCM 218 and its coupling to the SFM 230 are shown and will now be described more specifically. Although reference is made specifically to the situation where the SFM 230 is a camera, this is merely for convenience and the discussion is not limited a particular SFM. Those of skill in the art will appreciate that, in an alternative embodiment, the modules described in FIG. 9 may reside in the data storage device 606 rather than the memory 604.

As shown in FIG. 9, the memory 604 comprises several modules, some of which operate similarly to modules in the memory 504 of FIG. 8: a real time executive 902, a system setup module 904, a discovery module 906, a send data module 908, an external applications module 918, and a specific communication component 930 all coupled for communication with each other, with the communication interface 220 and with universal digital interface module 222 via bus 608.

The real time executive 902 is a conventional type known to those skilled in the art and controls interaction among the other modules of memory 604.

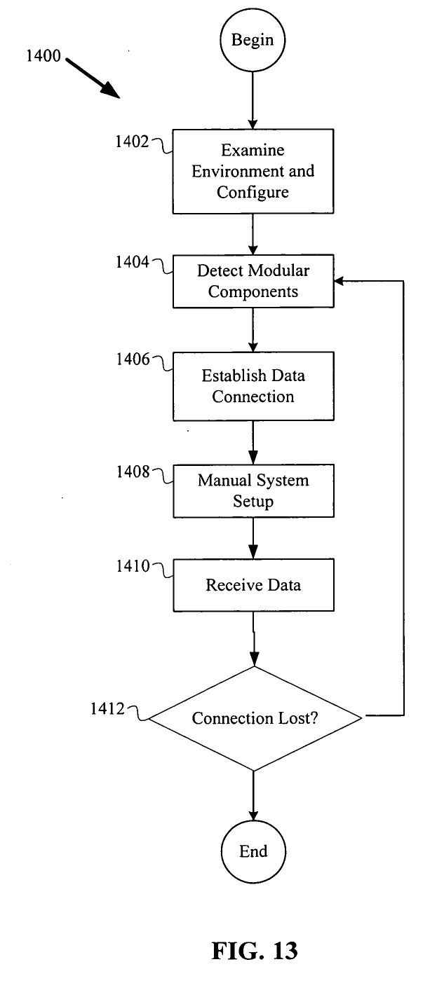

The system setup module 904 is for initializing the UCM 218 and the SFM 230. The system setup module 904 is responsive to the environment and determines initial system parameters for the UCM 218. The system setup module 904 is coupled to the discovery module 906 to trigger an announcement of the presence of the UCM 218 and any SFMs 230 coupled thereto, and it communicates with the record module 912 to provide initial system setup parameters. Additionally, the system setup module 904 includes an update capability, for receiving updated system parameters and distributing them to the other modules in memory 604. Furthermore, in an alternative embodiment, a user can independently interact with the system setup module 904 to alter system parameters. As will be apparent to one skilled in the art, the operation of the system setup module 904 is similar to that described below with reference to FIG. 13.

The discovery module 906 is coupled to the system setup module 904 and signals the presence of the UCM 218 and the SFM 230 in the modular security system 100. The discovery module 906 also facilitates re-announcing the presence of the UCM 218 and the SFM 230 when the connection is broken. As will be apparent to one skilled in the art, the operation of the discovery module 906 is similar to that described below with reference to FIG. 13 but for the signals that need to be sent from the UCM 218 to the control system 212.

The send data module 908 is responsible for network communication, for example, using an internet protocol (IP) stack, to transmit the data signal over the dual use medium 210. In particular, the send data module 908 encrypts the data signal if encryption is being used.

The external applications module 918 works in conjunction with the send data module 908 to send the data to remote applications, such as applications that may be located in the memory 504 of the computing device 216. Another example of an external application might be Windows® Media Player running on an external PC, in which a user enters a Uniform Resource Locator (URL) that identifies one of the SFMs to view data from the identified SFM.

The specific communication component 930 sends data to and receives data from the Specific Function Module 230. Although the specific communication component 930 is depicted within the memory 904 of the Universal Control Unit 224, one skilled in the art will recognize that the specific communication component 930 could also be located within the Universal Digital Interface Module 222.

The methods described below in FIG. 13 regarding the initialization of the modular security system 100 are presented particularly with respect to the embodiment of the security system 100 including the memory 504 of the computing device 216 as shown in FIG. 5. Those of skill in the art will realize that the methods described, with minor modifications, can also be used with the memory 604 of the UCM. Additional information regarding the operation and the live viewing, record, and search/playback modes, as well as associated user interfaces, of a surveillance system that operates using the Werks software can be found in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety.

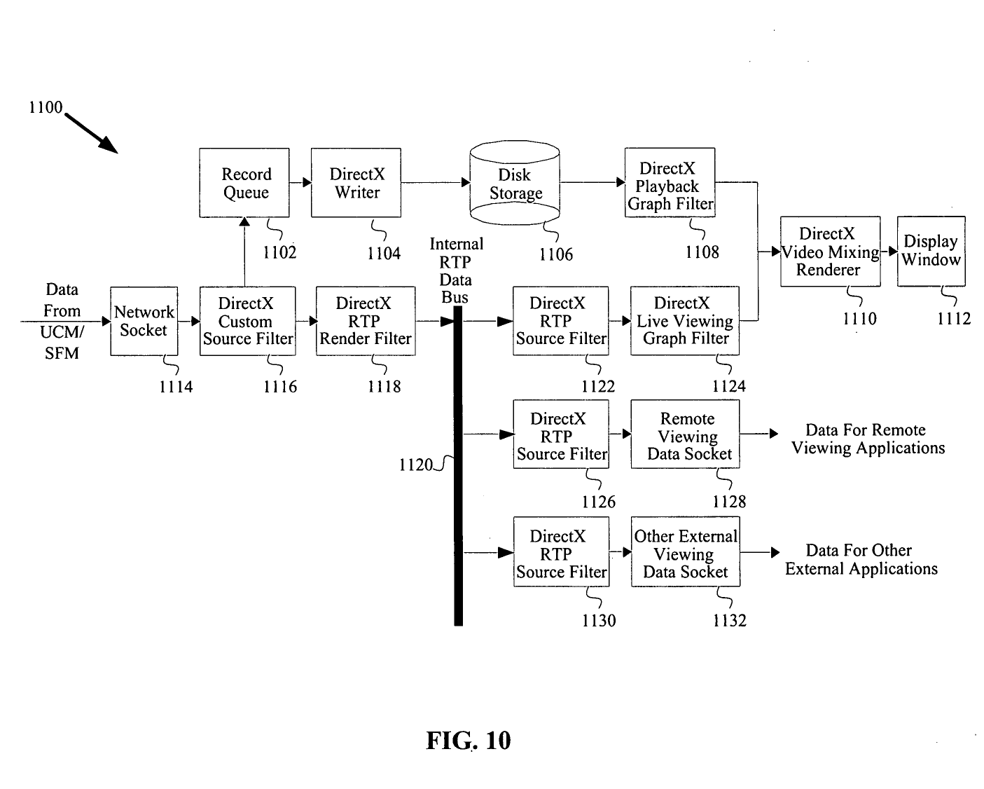

FIG. 10 is a functional diagram of a data flow 1100 for operation of the memory 504 of the computing device 216 of FIG. 5. The data flow 1100 represents the data flow for a single UCM-SFM combination. Each UCM-SFM combination connected to the modular security system 100 would have a data flow similar to data flow 1100. Although reference is made specifically to the UCM-SFM combination where the SFM is a camera, this is merely for convenience and the discussion is not limited a particular SFM. One of skill in the art will recognize that the data flow depicted in FIG. 10, with minor modification to account for the specific SFM being used, is representative of various UCM-SFM combinations.

Data from a UCM-SFM combination is presented to a network socket 1114, for example, via an Ethernet network IP socket connection. The network socket 1114 accomplishes the transfer of data from the UCM-SFM combination to the rest of the data flow 1100, using, for example, either TCP/IP or UDP/IP Ethernet packets. The network socket 1114 also implements a retry and recovery mechanism in the event of network failures or errors.

A DirectX custom source filter 1116 receives the data stream from the network socket 1114. The data from the UCM-SFM combination is received as standard Ethernet packets. This packet data is combined into frames, where each frame has a header, plus the information about each frame. The header contains time stamp information, a frame type, and-information about motion detection, if any, for that frame.

The frame type may be, for example, a Key frame or I frame. Most modern video compression schemes that achieve very high compression rates use a combination of Key frames and I frames. A Key frame is a stand-alone video frame, which can be rendered without any other information from previous frames. On the other hand, an I frame contains primarily information about how this particular I frame differs from the previous frame. Consequently, I frames are typically much smaller than Key frames, resulting in greater data compression. There are typically several I frames between Key frames, resulting in significant data reduction.

The output of the DirectX custom source filter 1116 is DirectX video frames, which are transmitted to a record queue 1102, to a DirectX RTP render filter 1118, or to both. In one embodiment, the frames of the video data stream (i.e., the sequence of video frames) are encoded using the Microsoft Windows® Media 9 compression format; however, the frames can also be encoded in any popular video format such as MJPEG, MPEG-2, MPEG-4, or other formats.

The DirectX RTP render filter 1118 receives video frames as input data and repackages these video frames into an RTP data stream and sends the data stream via the Internal RTP data bus 1120. The DirectX RTP render filter 1118 sends video data as RTP data packets via bus 1120 to any registered destinations, such as the DirectX RTP source filters 1122, 1126, and 1130.

If live viewing is active, the DirectX RTP source filter 1122 registers itself as a destination for the RTP render filter 1118 and then receives video frames via the RTP data bus 1120. The DirectX RTP source filter 1122 receives the RTP data packets, extracts the individual video frames from the RTP stream, and passes these video frames to the DirectX live viewing graph filter 1124. If live viewing is not active, no data is sent to the DirectX RTP source filter 1122 and subsequent blocks.

The DirectX live viewing graph filter 1124 processes the video frames and prepares them for presentation to the DirectX video mixing renderer (VMR) 1110. The VMR 1110 includes the Windows® Media 9 decoder function, which creates full video frames from the compressed sequence of Key frames and I frames. It also superimposes text and graphics information over the video images. The resultant displayable image is then rendered onto the surface of a designated display window 11 12. Each SFM 230 has a designated display window 1112.

Video data from the UCM-SFM combination that is received by the DirectX custom source filter 1116 is also sent to the record queue 1102. The record queue 1102 is used to deal with the video compression format, which reduces network bandwidth by using a combination of Key frames and I frames. For example, a user might wish to start recording at the moment motion is detected in the UCM-SFM combination. But, due to the Key/I frame composition of the compressed video data stream, a new recording must begin with a Key frame, since I frames cannot be rendered without the previous sequence of frames, back to the previous Key frame. The record queue 1102 stores the most recent set of frames, back to the most recent Key frame, or perhaps back a multiple number of Key frames if more information is stored in the record queue 1102. Thus, when recording is to start, the recording can begin at a Key frame prior to the trigger point. The temporary storage performed by the record queue 1102 may be organized as a software queue.

The DirectX writer 1104 receives video data from the record queue 1102 until the record queue 1102 is empty, and thereafter, the DirectX writer 1104 receives video data directly from the DirectX custom source filter 1116. When recording is initiated, the processor 502 supplies a filename to the DirectX writer 1104, which then writes a standard Windows® Media 9 (.wmv) data file under the designated disk filename in the disk storage 506. A particular feature of the present invention is that recording can start and stop as required, without disturbing the flow of video frames to the live viewing data path if live viewing is active.

A significant benefit derived from storing the recorded video data as standard Windows® Media 9 (.wmv) files is that the recorded video files can be played using the standard Windows® Media Player, and they can be viewed as thumbnail images in the Windows® Explorer. The recorded video files do not require the security system 100 for viewing. Thus, if a video clip is sent via email to some other location, it can be viewed using standard Windows® software components without requiring the security system 100 to be installed as a viewer.

When in search mode, the DirectX playback graph filter 1108 receives a filename corresponding to the file the user has selected for playback. The DirectX playback graph filter 1108 opens the file and begins playing the file by sending video frames to the VMR 1110, which renders the displayable video image to the designated display window 1112, similarly to the process used for live viewing. The user can specify a playback file position within the file, which is translated by the DirectX playback graph filter 1108 from an absolute playback time to a time relative to the start of the particular recorded file.

The DirectX playback graph filter 1108 also supports playback at rates other than normal (1×) playback speed. The DirectX playback graph filter 1108 is responsible for sending each frame on to the VMR 1110 at the correct time, according to the time stamp included with each video frame at the time it was acquired in the UCM-SFM combination, and according to the current playback rate (i.e., speed).

The internal RTP data bus 1120 provides a flexible means of distributing video samples from the UCM-SFM combination to multiple destinations. These destinations might include the live viewing display window 1112, a remote viewing connection, or another external viewing application. If remote viewing is active, the DirectX RTP render filter 1118 sends the video frames via the data bus 1120 to the DirectX source filter 1126, which sends the video data to a remote viewing data socket 1128 to transmit the data to a remote viewing application. If video data is intended for other external applications, the DirectX RTP render filter 1118 sends the video frames via the data bus 1120 to the DirectX source filter 1130, which sends the video data to an external viewing data socket 1132 to transmit the data to an external application such as a Microsoft Media Center PC.

As an example of remote viewing, the remote viewing data socket 1128 of the security system 100 facilitates monitoring of nearly-live video data feeds from the UCM-SFM combinations over the Internet. A user can specify one or more remote viewing locations, for example, Windows® Mobile enabled cell phones, handheld devices, Internet browsers on remote computing devices at a second home or office, and other devices that support Windows® Media 9 video. Examples of compatible cell phones include the Anextek SP230, Palm Treo 700w, and HP iPAQ hw6500 series. Examples of compatible wireless handled devices include the Asus MyPal A730W and Toshiba e805. Examples of compatible Internet browsers include Microsoft® Internet Explorer. Several such remote viewing locations may be enabled. When remote viewing is enabled, the computing device 216 acts as a video server ready to publish video from the secure environment created using the dual use network 210, over the Internet, to the remote viewing location.

One important consideration with the implementation of the RTP data bus 1120 and the RTP render filter 1118 is that destinations can be added or deleted without disturbing the operation of other destinations. For example, the DirectX RTP source filters 1126, 1130 can register themselves as destinations for the RTP render filter 1118 without disrupting other operations of the data flow 1100. In other words, the live viewing and/or recording do not have to temporarily halt while a remote viewing connection or external application destination is added or deleted. If remote or external viewing are not active, no data is sent to the DirectX RTP source filters 1126, 1130 and subsequent blocks.

Initialization and Operation of the Modular Security System

FIG. 13 is a flowchart of an exemplary embodiment of an initialization process 1400 for the modular security system 100 of the present invention. The initialization process 1400 is used, for example, with the memory 504 of the computing device 216 of FIG. 5. Those of skill in the art will appreciate that the modules described in the initialization process 1400 of FIG. 13 are not exclusive and need not be performed in the order described.

A significant advantage of the modular security system 100 of the present invention is ease of installation, which is accomplished in part using two wizards to help users make simple choices. When the memory 504 is first configured, for example, by installation via compact disk (CD), an installation wizard handles conventional tasks such as installing device drivers and copying required files to their proper destinations. When the modular security system 100 is operated for the first time, another wizard examines 1402 the user's computer environment and sets up the remaining required items that are machine-dependent. This includes, for example, determining disk storage location, and setting up parameters for a power line network, in the case where the dual use medium 210 is a building power line. Unless the user wishes to change a setting from the defaults suggested by the installation wizards, no user action is required other than to simply accept each suggestion.

Another way in which the modular security system 100 is characterized by ease of installations is through use of the dual use medium 210 to create a separate dedicated environment for the security system 100. Traditional networked modular components and computers can be difficult to set up properly due to the need to co-exist with other networked devices. These difficulties are avoided in the modular security system 100 through use of the dual use medium 210. The UCM-SFM combination can operate in its own separate dedicated environment and can co-exist with conventional network devices. For example, where the dual use medium 210 is a building power line system, few homes will have pre-existing power line networks, which means the examination 1402 process can determine address assignments and settings without worrying about compatibility with other devices. A separate network interface connection (NIC) is created on the computing device 216 to service the environment of the modular security system 100.

Another consideration addressed during the examination step 1402 of the initialization process 1400 is firewall handling, which also contributes to the ease of installation. Many computers contain built-in firewalls, which present a difficult issue for computer peripheral components used in networked systems, such as the modular security system 100. Many users may not know what firewall(s) are present or how to configure them. During the examination 1402 of the computer environment, special test functions are used to detect and display helpful information to the user regarding firewalls. Such information includes (1) whether any firewall is preventing proper operation of the security system 100, and (2) what type of traffic is currently being blocked (e.g., UDP broadcast, UDP P-P, TCP P-P, and Universal Plug and Play). For the most popular firewall programs, a message is displayed to the user, notifying the user of the presence of the particular firewall.

For some common firewall programs, for example, the built-in Windows XP® firewall, the installation wizard used in the examination 1402 step can automatically reconfigure the firewall to allow the security system 100 to operate normally. If such automatic reconfiguration is not possible, the installation wizard invokes a help system that displays information telling the user how to reconfigure the firewall to permit operation of the security system 100. This directed troubleshooting process performs the most difficult parts of the task for the user—determining that there is a firewall problem and what needs to be changed in the firewall setup—and provides appropriate information to the user.

The initialization process 1400 also includes a system to automatically detect 1404 the UCM-SFM combinations coupled thereto. The modular security system 100 employs the industry standard Universal Plug and Play (UPNP) protocol to establish a connection between the UCM 218 and the control system 212, in particular the memory 504. The UPnP protocol provides reliable discovery and control between units operating on a common network segment (e.g., network 210).

When the UCM 218 and SFM 230 are first coupled, the UCM 218 announces the presence of the SFM 230 over the dual use medium 210 with an UPnP “notify” message. The UCM 218 continues to do so periodically, according to the UPnP protocols. Similarly, as part of the initialization process 1400, UPnP “search” messages are sent out by the control system 212, requesting that any of the UCM-SFM combinations announce their presence. This UPnP discovery process provides a very reliable means of automatically detecting 1404 the presence of the UCM-SFM combinations in the modular security system 100. The user simply plugs in a UCM 218 to a power outlet and connects the PC 216 to the dual use medium 210 (e.g., a power line) through the transceiver 214 (e.g., a USB power line adapter).

Once a UCM 218 is detected, the initialization process 1400 establishes 1406 a connection with the UCM 218. The architecture combines DirectX components with custom software components to achieve the connection as the interface between the UCM 218 and control system 212. Connection times are generally about one second, and typical steady-state latency times are on the order of one-third to one-half second. The connection time is longer than the steady-state latency because the control system 212 must wait for the next Key frame to come from the UCM 218, which may occur about every one second. In one embodiment, the control system 212 may request the UCM 218 to send a Key frame on demand, so that no waiting is required, reducing the connection time. The reduced connection and steady-state latency times provide the feel of a “real-time” video connection, which is possible due to elimination of the conventional network buffer. Elimination of the conventional buffer is feasible because the security system 100 employs a dedicated communication environment via the dual use medium 210, which allows a much tighter control of latency than traditional networks such as the Internet can provide.

The user can then insert one or more SFMs 230 into an opening in the UCM 218. In one embodiment, the UCM 218 detects the presence of the SFM 230 via the coupling of the universal digital interface module 222 and the specific digital interface module 428. The UCM 218 serves only as a network connection and does not depend on which SFM 230 is using it. Each UCM 218 has a unique MAC address for identification by the software application, which also identifies the function of whichever SFM 230 may be inserted in the UCM.

If a connection to a UCM 218 is “lost” 1412 due to some temporary problem with the connection, the detect 1404 modular components step sends out new search messages to attempt to reestablish the connection to the UCM 218. This particular portion of the initialization process 1400 remains active throughout the operation of the modular security system 100 to address lost UCM 218 connections that may occur at any time during operation.

A user can accept the default configuration suggested by the installation wizards during the examine environment and configure step 1402. Alternatively, a user can choose to modify parameters via a manual system setup 1408, which includes a graphical user interface. The graphical user interface is described in more detail in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety.

The initialization process 1400 receives data 1410 from all UCM-SFM combinations detected 1404 on the dual use medium 210. The data from the UCM 218 is sent as a special digitally-encoded data stream over the dual use medium 210 to the control system 212. To enhance security for the data, a system password entered by the user, as described above, is used as an encryption key for the data on the dual use medium 210. Without this encryption key, the data cannot be decrypted or viewed by another party, even if such a party were to gain physical access to the user's dual use medium 210, which may be a power line, and can “see” the data.

The initialization process 1400 of FIG. 13 was described particularly in the context of the memory 504 of the computing device 216 of FIG. 5. Those of skill in the art will appreciate that, with minor modifications, the modules described in the initialization process 1400 of FIG. 13 may also apply for use with the memory 604 of the UCM 218 of FIG. 6. For example, the examine environment 1402 step may be used to configure the UCM-SFM combination for local recording in the absence of the existence of the control system 212. The detect modular components 1404 step may control sending of the “notify” message in accordance with the UPnP protocol, while the lost connection 1412 step may control resending of the “notify” message. The system setup 1408 may be accomplished via firmware hard-coded into the UCM-SFM combination, and may include settings such as a default record mode and default motion detection zones. Lastly, the receive data 1410 step may in fact be a send data step to facilitate transfer of the data to a remote viewing client or application. Other modifications may also suggest themselves to those of skill in the art.

Detailed descriptions of exemplary embodiments for a security system using the Werks application for an operating process, a live viewing mode, a record mode, and a search/playback mode, as well as exemplary graphical user interfaces for performing system setup, a live viewing mode, and a search/playback mode can be found in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety.

UCM Integrated with SFM in a Single Structure

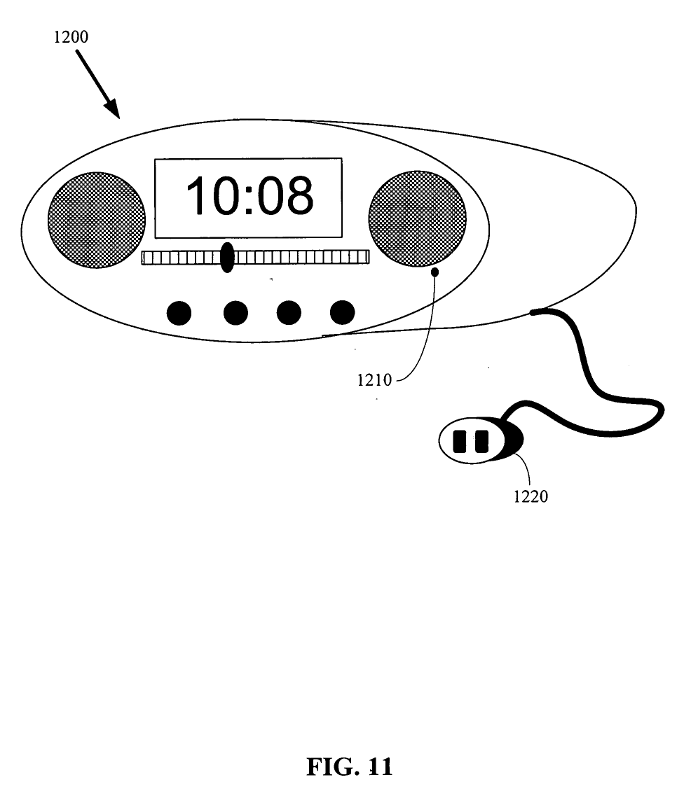

Referring now to FIG. 11, the indoor covert camera is one example of a UCM and a SFM integrated within a single structure. The covert camera may be embedded in, for example, a standard AM/FM radio/alarm clock and operates on similar principles as the personal indoor camera described previously and in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety. Power for the camera may be provided by the clock radio, either through direct connection with the building's 120V power supply, such as through plug 1220, or via batteries. A pinhole lens 1210 may be used to disguise the presence of the camera. The camera may transmit video wirelessly or through a power line communication to the software application.

Those skilled in the art will realize that the covert indoor camera is not limited to clock radios and may be designed in a variety of standard consumer electronic devices. The hidden camera may be used in conjunction with other UCM-SFM combinations to provide for more comprehensive monitoring for modular security system 100.

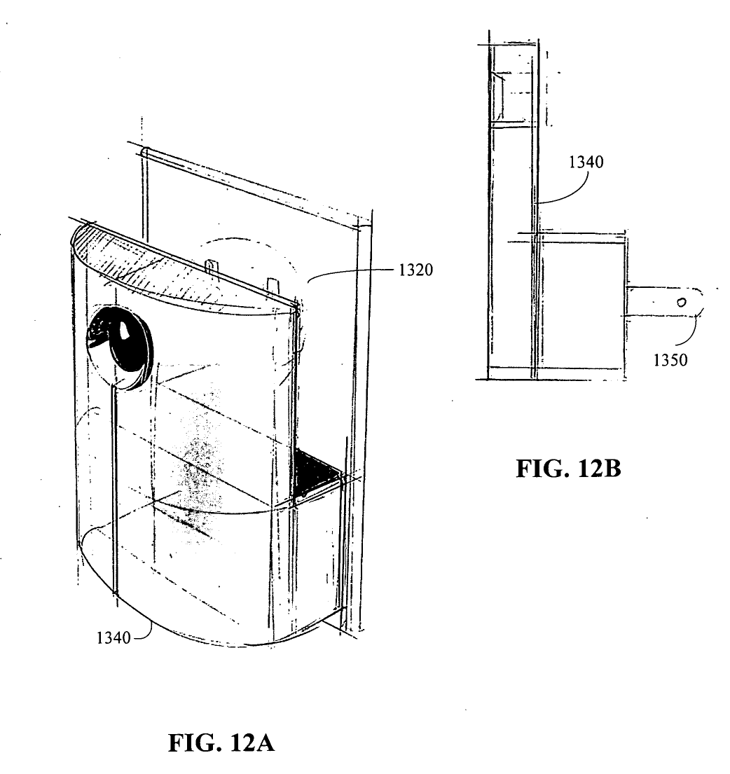

Referring now to FIGS. 12A-12B, the outlet camera is another example of a UCM and a SFM integrated within a single structure 1340. FIG. 12A is a perspective view of an exemplary embodiment of an outlet camera. FIG. 12B is a side view of the outlet camera shown in FIG. 12A.

In this embodiment, the outlet camera 1340 simply plugs directly into a power outlet 1320 through prongs 1350. When plugged in, the outlet camera transmits video signal data to a PC via the building power line. The outlet camera is fully encapsulated and operates on similar principles as the personal indoor camera described previously and in U.S. patent application Ser. No. 11/325,204, titled “Video Surveillance System” to Thomas R. Rohlfing, et al., Attorney Docket No. 23839-09957, filed Jan. 3, 2006, which is incorporated by reference in its entirety.

Moreover, the outlet camera may be used in conjunction with the UCM-SFM combinations to provide for more comprehensive monitoring for security system 100. In the outlet camera, the connector to the power line is integrated into the housing of the outlet camera. The outlet camera is an ideal camera for very portable applications. A business owner, for example, could monitor a stock room or area where he is having employee or client theft problems one day and then move the outlet camera to a different location the next day.

The connector of the outlet camera may be modified for various service voltage standards, for example, to connect to 120V AC power lines, or 220V lines, or for various foreign connector standards. In particular, the prongs of the outlet camera may be modified to connect to various power outlet receptacles.

In an alternative embodiment, the outlet camera may include a power pass-through so that access to the power receptacle to which the outlet camera is plugged in is not hindered. In this embodiment, the front of the outlet camera housing includes a female outlet to provide access to the power receptacle.

The foregoing description has been presented for the purpose of illustration; it is not intended to be exhaustive or to limit the invention to the precise forms disclosed. Persons skilled in the relevant art can appreciate that many modifications and variations may be possible.

The modular security system of the present invention preserves the advantages of traditional surveillance system while overcoming many of its deficiencies by providing a low cost, user friendly, multi-functional security system.

Upon reading this disclosure, those of skill in the art will appreciate additional alternative structural and functional designs for systems and processes for surveillance through the disclosed principles of the present invention. Thus, while particular embodiments and applications of the present invention have been illustrated and described, the invention is not limited to the precise construction and components disclosed herein and various modifications, changes and variations, which will be apparent to those skilled in the art, may be made in the arrangement, operation, and details of the methods and apparatus of the present invention disclosed herein without departing from the spirit and scope of the invention as defined in the appended claims.

1. A security system comprising:
a dual use medium;
a first universal communication module coupled to the dual use medium, the first universal communication module having an input and an output for providing a communication channel;
a first specific function module coupled to the first universal communication module, the first specific function module adapted for communication with the first universal communication module and to perform a specific function; and
a control system having a control transceiver communicatively coupled to the dual use medium for communication with the first universal communication module.

2. The system of claim 1, wherein the dual use medium is a power line.

3. The system of claim 1, wherein the universal communication module is structurally adapted for mounting the specific function module to provide the coupling between the universal communication module and the specific function module.

4. The system of claim 1, wherein the universal communication module comprises:
a communication interface having an input and an output for sending and receiving signals over the dual use medium;
a universal control unit coupled to the communication interface, the universal control unit processing signals sent or received by the universal communication module; and
a universal digital interface module coupled to the universal control unit, the universal digital interface module having an input and an output for communicating with the specific function module.

5. The system of claim 4, wherein the specific function module comprises:
a specific digital interface module having an input and an output for sending signals to and receiving signals from the universal communication module; and
a functional component for executing a specific function, coupled to the specific digital interface module.

6. The system of claim 5, wherein the universal communication module further comprises a power interface that allows power to flow to the specific function module.

7. The system of claim 5, wherein the functional component comprises a specific control unit for processing signals sent or received by the specific function module.

8. The system of claim 6, wherein the functional component comprises a specific control unit for processing signals sent or received by the specific function module.

9. The system of claim 6, wherein the specific function module further comprises a power line switch adapted for switching the power signal connection between the power line and the specific function module, the power line switch coupled to the functional component.

10. The system of claim 1, wherein the specific function module further comprises an interface to an external device, the interface having an input and an output for sending signals to and receiving signals from the external device.

11. The system of claim 10, wherein the external device is a network..

12. The system of claim 8, wherein the specific function module further comprises one selected from the group consisting of:
a video surveillance camera coupled to the specific control unit;
a garage door interface module coupled to the specific control unit configured in response to a control signal to activate a garage door opener;
a sounder alarm module coupled to the specific control unit configured to receive data captured by an input device, send the captured data to the specific control unit, and activate an alarm in response to the receipt of a control signal;
a microphone module coupled to the specific control unit configured to receive data captured by a microphone and send the captured data to the specific control unit;
a smoke detector module coupled to the specific control unit configured to receive data captured by a smoke detector and send the captured data to the specific control unit;
a carbon monoxide detector module coupled to the specific control unit configured to receive data captured by a smoke detector and send the captured data to the specific control unit;
a camera module coupled to the specific control unit configured to receive data captured by a camera and send the captured data to the specific control unit
a door/window sensor module coupled to the specific control unit configured to receive data captured by an input device and send the captured data to the specific control unit;
a Form C control module coupled to the specific control unit providing Form C contacts to control an external device configured to receive the Form C contacts;
a TV/PIP analog interface module coupled to the specific control unit configured to send video data from a surveillance camera to a device for displaying;
an IP-device interface module coupled to the specific control unit configured in response to a control signal to activate a device adapted to receive signals from the IP-device interface module;
a central station link module coupled to the specific control unit and an alarm, the central station link module sending data about specified decibel levels from the alarm to the special control unit, the special control unit communicating with a central station in response to the sending of the decibel level data;
a weather station receiver module coupled to the specific control unit configured to receive data captured by a personal weather station and to send the data captured to the specific control unit, the personal weather station configured to send data to the weather station receiver module;
a HomePlug-enabled alarm verification module coupled to the specific control unit, an alarm and a video camera, the verification module displaying the field of view of the camera in response to specified criteria about the alarm; and
an Insteon-enabled module coupled to the specific control unit and an alarm, the Insteon-enabled module communicating with a central monitoring station in response to specified criteria about the alarm.

13. The system of claim 12, wherein the video camera further comprises a camera transceiver communicatively coupled to the specific control unit configured to send video data captured by the camera to the specific control unit and to receive control signals from the specific control unit.

14. The system of claim 6, wherein the specific function module further comprises a lamp module configured to adjust the amount of light emitted from a lamp in response to a control signal.

15. The system of claim 7, wherein the specific function module further comprises an infrared motion detector coupled to the specific control unit configured to send data captured by the detector to the specific control unit and to receive control signals from the specific control unit.

16. The system of claim 1, further comprising:
a second universal communication module coupled to the dual use medium, the second universal communication module having an input and an output for providing a communication channel; and
a second specific function module coupled to the second universal communication module, the second specific function module adapted for communication with the second universal communication module and to perform a specific function.

17. The system of claim 16, further comprising:
a third specific function module coupled to the first universal communication module, the third specific function module adapted for communication with the first universal communication module and to perform a specific function.

18. The system of claim 17, wherein the first universal communication module is structurally adapted for mounting the first specific function module and the third specific function module to provide the coupling between the first universal communication module and the first and third specific function modules.

19. The system of claim 1, wherein the control system is configured to allow remote access to a user.

20. The system of claim 1, further comprising:
a first camera having a camera transceiver communicatively coupled to the dual use medium, the camera transceiver configured to send video data captured by the first camera over the dual use medium and to receive control signals over the dual use medium from the control transceiver, wherein the control transceiver is communicatively coupled to the dual use medium for a low latency video connection with the first camera, the control transceiver configured to receive video data from the first camera via the dual use medium and to send control signals to the first camera over the dual use medium.

21. A method of operating a security system, the method comprising:
establishing a connection to a first universal communication module over a dual use medium by a control system;
in response to the coupling of a first specific function module with the first universal communication module, receiving a first signal from the first universal communication module over the dual use medium;
processing the received first signal to produce a first data signal; and
outputting the first data signal.

22. The method of claim 21, wherein the universal communication module comprises:
a communication interface having an input and an output for sending and receiving signals over the dual use medium;
a universal control unit coupled to the communication interface, the universal control unit processing signals sent or received by the universal communication module; and
a universal digital interface module coupled to the universal control unit, the universal digital interface module having an input and an output for communicating with the specific function module.

23. The method of claim 22, wherein the specific function module comprises:
a specific digital interface module having an input and an output for sending signals to and receiving signals from the universal communication module; and
a functional component for executing a specific function, coupled to the specific digital interface module.

24. The method of claim 23, wherein the specific function module further comprises:
a specific control unit for processing signals sent or received by the specific function module coupled to a specific digital interface module, the specific digital interface module having an input and an output for sending signals to and receiving signals from the universal communication module.

25. The method of claim 21, further comprising:
coupling a second specific function module with the first universal communication module;
receiving a second signal from the first universal communication module over the dual use medium;
processing the received second signal to produce a second data signal; and
outputting the second data signal.

26. The method of claim 25, further comprising:
establishing a connection to a second universal communication module over the dual use medium by the control system;
in response to the coupling of a third specific function module with the second universal communication module, receiving a third signal from the second universal communication module over the dual use medium;
processing the received third signal to produce a third data signal; and
outputting the third data signal.

27. The method of claim 21, wherein establishing the connection further comprises:
automatically detecting a coupling of the universal communication module to the dual use medium; and
automatically detecting a coupling of the specific function module to the universal communication module.

28. The method of claim 21, further comprising displaying a graphical user interface for control of the security system, the graphical user interface allowing formatting of a receiving window, displaying the data in the receiving window, displaying a universal communication module status indicator, displaying a specific function module status indicator, allowing activation or deactivation of the universal communication module, and allowing activation or deactivation of any of the specific function modules.

29. The method of claim 25, wherein the step of outputting the first and second data signals includes storing the first and second data signals on a storage device.

30. The method of claim 25, wherein the step of outputting the first and second data signals includes storing the first and second data signals on a storage device, and responsive to input from the user searching and displaying the first and second data signals.

31. The method of claim 21, further comprising sending a notification to a recipient, the notification responsive to a trigger.

32. An apparatus comprising:
a universal communication module coupled to a dual use medium, the universal communication module having an input and an output for providing a communication channel.

33. The apparatus of claim 32, further comprising:
a specific function module coupled to the universal communication module, the specific function module adapted for communication with the universal communication module and to perform a specific function.

34. The apparatus of claim 33, wherein the universal communication module is structurally adapted for mounting the specific function module to provide the coupling between the universal communication module and the specific function module.

35. The apparatus of claim 33, wherein the universal communication module comprises:
a communication interface having an input and an output for sending and receiving signals over the dual use medium;
a universal control unit coupled to the communication interface, the universal control unit processing signals sent or received by the universal communication module; and
a universal digital interface module coupled to the universal control unit, the universal digital interface module having an input and an output for communicating with the specific function module.

36. The apparatus of claim 33, wherein the specific function module comprises
a specific digital interface module having an input and an output for sending signals to and receiving signals from the universal communication module; and
a functional component for executing a specific function, coupled to the specific digital interface module.

37. The apparatus of claim 36, wherein the universal communication module further comprises a power interface that allows power to flow to the specific function module.

38. The apparatus of claim 36, wherein the functional component comprises a specific control unit for processing signals sent or received by the specific function module.

39. The apparatus of claim 37, wherein the functional component comprises a specific control unit for processing signals sent or received by the specific function module.

40. The apparatus of claim 37, wherein the specific function module further comprises a power line switch adapted for switching the power signal connection between the power line and the specific function module, the power line switch coupled to the functional component.

41. The apparatus of claim 33, wherein the specific function module further comprises an interface to an external device, the interface having an input and an output for sending signals to and receiving signals from the external device.

42. The apparatus of claim 41, wherein the external device is a network.

43. The apparatus of claim 39, wherein the specific function module further comprises one selected from the group consisting of:
a video surveillance camera coupled to the specific control unit;
a garage door interface module coupled to the specific control unit configured in response to a control signal to activate a garage door opener;
a sounder alarm module coupled to the specific control unit configured to receive data captured by an input device, send the captured data to the specific control unit, and activate an alarm in response to the receipt of a control signal;
a microphone module coupled to the specific control unit configured to receive data captured by a microphone and send the captured data to the specific control unit;
a smoke detector module coupled to the specific control unit configured to receive data captured by a smoke detector and send the captured data to the specific control unit;
a carbon monoxide detector module coupled to the specific control unit configured to receive data captured by a smoke detector and send the captured data to the specific control unit;
a camera module coupled to the specific control unit configured to receive data captured by a camera and send the captured data to the specific control unit
a door/window sensor module coupled to the specific control unit configured to receive data captured by an input device and send the captured data to the specific control unit;
a Form C control module coupled to the specific control unit providing Form C contacts to control an external device configured to receive the Form C contacts;
a TV/PIP analog interface module coupled to the specific control unit configured to send video data from a surveillance camera to a device for displaying;
an IP-device interface module coupled to the specific control unit configured in response to a control signal to activate a device adapted to receive signals from the IP-device interface module;
a central station link module coupled to the specific control unit and an alarm, the central station link module sending data about specified decibel levels from the alarm to the special control unit, the special control unit communicating with a central station in response to the sending of the decibel level data;
a weather station receiver module coupled to the specific control unit configured to receive data captured by a personal weather station and to send the data captured to the specific control unit, the personal weather station configured to send data to the weather station receiver module;
a HomePlug-enabled alarm verification module coupled to the specific control unit, an alarm and a video camera, the verification module displaying the field of view of the camera in response to specified criteria about the alarm; and
an Insteon-enabled module coupled to the specific control unit and an alarm, the Insteon-enabled module communicating with a central monitoring station in response to specified criteria about the alarm.

44. The apparatus of claim 43, wherein the video camera further comprises a camera transceiver communicatively coupled to the specific control unit configured to send video data captured by the camera to the specific control unit and to receive control signals from the specific control unit.

45. The apparatus of claim 37, wherein the specific function module further comprises a lamp module configured to adjust the amount of light emitted from a lamp in response to a control signal.

46. The apparatus of claim 38, wherein the specific function module further comprises an infrared motion detector coupled to the specific control unit configured to send data captured by the detector to the specific control unit and to receive control signals from the specific control unit.

47. The apparatus of claim 33, further comprising:
a second specific function module coupled to the universal communication module, the second specific function module adapted for communication with the universal communication module and to perform a specific function.

48. An apparatus comprising:
a specific function module coupled to a universal communication module, the specific function module adapted for communication with the universal communication module and to perform a specific function.

49. The apparatus of claim 48, wherein the specific function module is structurally adapted for insertion into the universal communication module to provide the coupling between the specific function module and the universal communication module.

50. The apparatus of claim 48, wherein the specific function module comprises
a specific digital interface module having an input and an output for sending signals to and receiving signals from the universal communication module; and
a functional component for executing a specific function, coupled to the specific digital interface module.

51. The apparatus of claim 50, wherein the universal communication module further comprises a power interface that allows power to flow to the specific function module.

52. The apparatus of claim 50, wherein the functional component comprises a specific control unit for processing signals sent or received by the specific function module.

53. The apparatus of claim 51, wherein the functional component comprises a specific control unit for processing signals sent or received by the specific function module.

54. The apparatus of claim 51, wherein the specific function module further comprises a power line switch adapted for switching the power signal connection between the power line and the specific function module, the power line switch coupled to the functional component.

55. The apparatus of claim 48, wherein the specific function module further comprises an interface to an external device, the interface having an input and an output for sending signals to and receiving signals from the external device.

56. The apparatus of claim 55, wherein the external device is a network.

57. The system of claim 53, wherein the specific function module further comprises one selected from the group consisting of:
a video surveillance camera coupled to the specific control unit;
a garage door interface module coupled to the specific control unit configured in response to a control signal to activate a garage door opener;
a sounder alarm module coupled to the specific control unit configured to receive data captured by an input device, send the captured data to the specific control unit, and activate an alarm in response to the receipt of a control signal;
a microphone module coupled to the specific control unit configured to receive data captured by a microphone and send the captured data to the specific control unit;
a smoke detector module coupled to the specific control unit configured to receive data captured by a smoke detector and send the captured data to the specific control unit;
a carbon monoxide detector module coupled to the specific control unit configured to receive data captured by a smoke detector and send the captured data to the specific control unit;
a camera module coupled to the specific control unit configured to receive data captured by a camera and send the captured data to the specific control unit
a door/window sensor module coupled to the specific control unit configured to receive data captured by an input device and send the captured data to the specific control unit;
a Form C control module coupled to the specific control unit providing Form C contacts to control an external device configured to receive the Form C contacts;
a TV/PIP analog interface module coupled to the specific control unit configured to send video data from a surveillance camera to a device for displaying;
an IP-device interface module coupled to the specific control unit configured in response to a control signal to activate a device adapted to receive signals from the IP-device interface module;
a central station link module coupled to the specific control unit and an alarm, the central station link module sending data about specified decibel levels from the alarm to the special control unit, the special control unit communicating with a central station in response to the sending of the decibel level data;
a weather station receiver module coupled to the specific control unit configured to receive data captured by a personal weather station and to -send the data captured to the specific control unit, the personal weather station configured to send data to the weather station receiver module;
a HomePlug-enabled alarm verification module coupled to the specific control unit, an alarm and a video camera, the verification module displaying the field of view of the camera in response to specified criteria about the alarm; and
an Insteon-enabled module coupled to the specific control unit and an alarm, the Insteon-enabled module communicating with a central monitoring station in response to specified criteria about the alarm.

58. The apparatus of claim 57, wherein the video camera further comprises a camera transceiver communicatively coupled to the specific control unit configured to send video data captured by the camera to the specific control unit and to receive control signals from the specific control unit.

59. The apparatus of claim 51, wherein the specific function module further comprises a lamp module configured to adjust the amount of light emitted from a lamp in response to a control signal.

60. The apparatus of claim 52, wherein the specific function module further comprises an infrared motion detector coupled to the specific control unit configured to send data captured by the detector to the specific control unit and to receive control signals from the specific control unit.
